(19) United States
(12) Patent Application Publication
(10) Pub. No.: US 2012/0068538 A1
(43) Pub. Date: Mar. 22, 2012

(54) ELECTRONIC DEVICE HAVING DATA TRANSMISSION INTERFACE CAPABLE OF RECEIVING EXTERNAL POWER AND TRANSMITTING ELECTRONIC DATA

(75) Inventors: Zhou Ye, Foster City, CA (US); Tsung-Yu Chen, Taipei (TW)

(73) Assignee: CYWEE GROUP LIMITED, Tortola (VG)

(21) Appl. No.: 12/886,521

(22) Filed: Sep. 20, 2010

(51) Int. Cl. H02J 1/00

(52) U.S. Cl. 307/43

(57) ABSTRACT

The present invention is related to an electronic device capable of transmitting electronic data and receiving power input via at least one data transmission interface and the method thereof. The electronic device of the present invention utilizes data transmission interfaces of different standards to receive electrical power as well as electronic data via said different data transmission interfaces simultaneously. The first data transmission interface circuit is configured to receive electric power from a first external power source and the second data transmission interface is configured to receive electric power from a second external power source.

### BACKGROUND OF THE INVENTION

1. Field of the Invention

The present invention relates generally to an electronic apparatus having multiple data transmission interfaces, and more particularly, to an electronic apparatus capable of delivering electrical power and transmitting electronic data utilizing more than one data transmission interfaces of different standards, and the method of operation thereof.

2. Description of the Prior Art

There exist various ways of supplying electrical power to electronic devices to maintain its operation and function including such as AC power adapter, batteries, switching power supply apparatus and DC power supply. Recent development and the utilization of a standardized connector known as Universal Serial Bus (USB) may too be configured to carry electrical power therethrough from a power source to an electronic device integrated with such USB connector and cable.

Please refer to FIG. 1 illustrating a conventional way of supplying an electronic device with electrical power. As shown in FIG. 1, an electronic device 100 may obtain electrical power from USB cable assemblies 110, 120 and/or an AC power adapter 130. The AC power adapter 130 accepts power inputs of multiple regions and specifications; however, in situations where no AC power source is available and no current is drawn from the AC power adapter 130 to the electronic device 100, one of the USB cable assemblies 110 and 120 must then be utilized for data transmission. For example, according to known specification of portable electronic devices, most USB devices may be able to transmit or handle 5V/500 mA of power and current input at one single USB port and connector only. In situations where such required 5V/500 mA of input power and current is insufficient or the electronic USB device requires greater power and current, in order to maintain the proper functioning and operation of the electronic device 100, other source of power must be supplemented to compensate the required input power and current of the USB cable assemblies 110 and 120.

An alternative of supplementing the insufficient power and current to an electronic device supplied by one single USB port is to either provide another power source means, such as AC power adaptor, or to provide another USB port and connector to compensate the required power and current of the USB device. For example, for portable electronic devices (e.g., a USB dongle) the AC power adapter may not be optimal to users as it can be bulky and heavy in comparison to the portable device itself. In addition, since most portable devices, such as a USB dongle, may not be designed to equip more than one USB ports and cables and the internal power control circuitry on board may not be designed to handle multiple power input from more than one single USB port; in other words, it is not a practical solution to utilize two USB cable assemblies on one single USB portable device as a means of gaining and transmitting power from power source to achieve a combined power satisfying the power and current demand of the USB portable device. The conventional art of supplying the electronic device with electrical power is therefore insufficient and impractical.

### SUMMARY OF THE INVENTION

In view of the above, the present invention provides a solution utilizing more than one data transmission interface of different data transmission standards for receiving electrical power from power source(s) to supply an electronic device with power.

According to one exemplary embodiment of the present invention, an electronic device comprises a first data transmission interface and a second data transmission interface. The first data transmission interface is configured to receive a first power input from a first external power source; and the second data transmission interface is configured to receive a second power input from a second external power source. The first data transmission interface is of a first data transmission standard different from a second data transmission standard of the second data transmission interface.

In another exemplary embodiment of the present invention, a method of supplying an electronic device with electrical power comprises the steps of utilizing a first data transmission interface for receiving a first power input from a first external power source; and utilizing a second data transmission interface for receiving a second input power from a second external power source; and wherein, the first data transmission interface is of a first data transmission standard different from a second data transmission standard of the second data transmission interface.

In one particular example of the abovementioned first data transmission interface according to one embodiment of the present invention may preferably be a high definition multimedia interface (HDMI); and the second data transmission interface may be an USB interface adopting a data transmission standard different from the one of the HDMI.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional way of supplying an electronic device with electrical power;

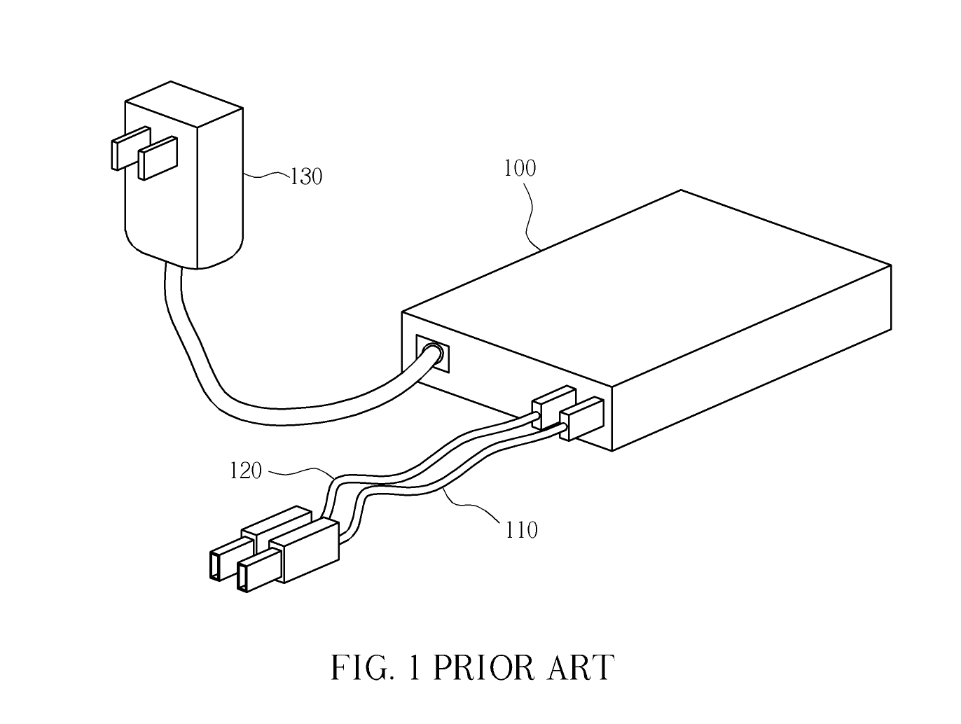

FIG. 2 illustrates an electronic device according to a first exemplary embodiment of the present invention;

FIG. 3 illustrates an electronic device according to a second exemplary embodiment of the present invention;

FIG. 4 illustrates an electronic device according to a third exemplary embodiment of the present invention; and

FIG. 5 illustrates an electronic device according to a fourth exemplary embodiment of the present invention.

### DETAILED DESCRIPTION

The present invention is described with reference to various exemplary embodiments. It will be clear that various modifications and changes may be made thereto without departing from the broader spirit and scope of the invention. Furthermore, the following descriptions of various embodiments of the present invention accompanying with the drawings are for illustrative purposes only and shall not be treated as a limitation to the scope of the present invention. Furthermore, similar components and elements are designated with same references in the accompanied drawings may be of similar functions and operations.

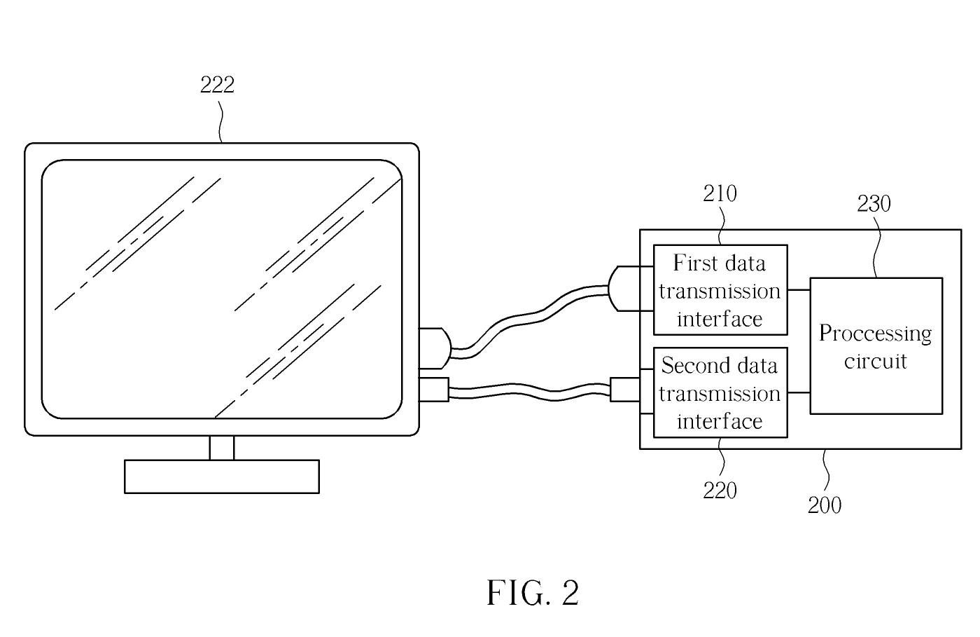

Please refer to FIG. 2 illustrating an electronic device according to a first exemplary embodiment of the present invention. An electronic device 200 comprises a first data transmission interface 210, a second data transmission interface 220 and a processing unit 230. The electronic device 200 may be a handheld game console, a multimedia playback device, a set-top box etc. The electronic device 200 may be coupled to an entertainment system 222, such as a high definition display device (e.g. HDTV). The electronic device 200 may utilize the first data transmission interface 210 for transmitting high definition digital video (HDMI) signals or/and uncompressed/compressed digital audio signals to the entertainment system 222. The first data transmission interface 210 may be a HDMI and the electronic device 200 is coupled to the electronic device 222 via an HDMI connection cable to connect the HDMI interface in the entertainment system 222 As HDMI standard is electrically compatible with the digital visual interface (DVI) standard, in another embodiment, the first data transmission interface 210 may too be implemented with a DVI interface. In order to obtain or gain power input from a power source external to the electronic device 200, the first data transmission interface 210 is configured to receive a first power input from a first external power source 211 disposed in the entertainment system 222. Furthermore, the second data transmission interface 220 is configured to receive a second power input from a second external power source 221 disposed in the entertainment system 222. The second data transmission interface 220 may be an USB interface, a different data transmission standard from the first data transmission interface 210. Additionally, the second data transmission interface 220 is coupled to the entertainment system 222 via an USB connection cable to connect the USB interface on the entertainment system 222. As an illustrative example, the electronic device 222 may be an HDTV which may transmit its AC/DC power supply connected thereto as a means of providing the abovementioned first external power source 211 and the second external power source 221.

Furthermore, the first data transmission interface 210 and the second data transmission interface 220 may be electrically connected to a power regulator integrated in the electronic device 200. The power regulator may control and stabilize the electrical power transmitted to the processing unit 230. According to another embodiment of the present invention, the first data transmission interface 210 may be an HDMI interface; in an illustrative example the HDMI interface 210 may receive a 5V electrical power of 50 mA maximum from the first external power source 211; and second data transmission interface 220 may be an USB interface, the USB interface 220 may receive a 5V electrical power of 500 Ma maximum from the second external power source 221. In addition, the electronic device 200 may too utilize a conventional power adapter (not shown).

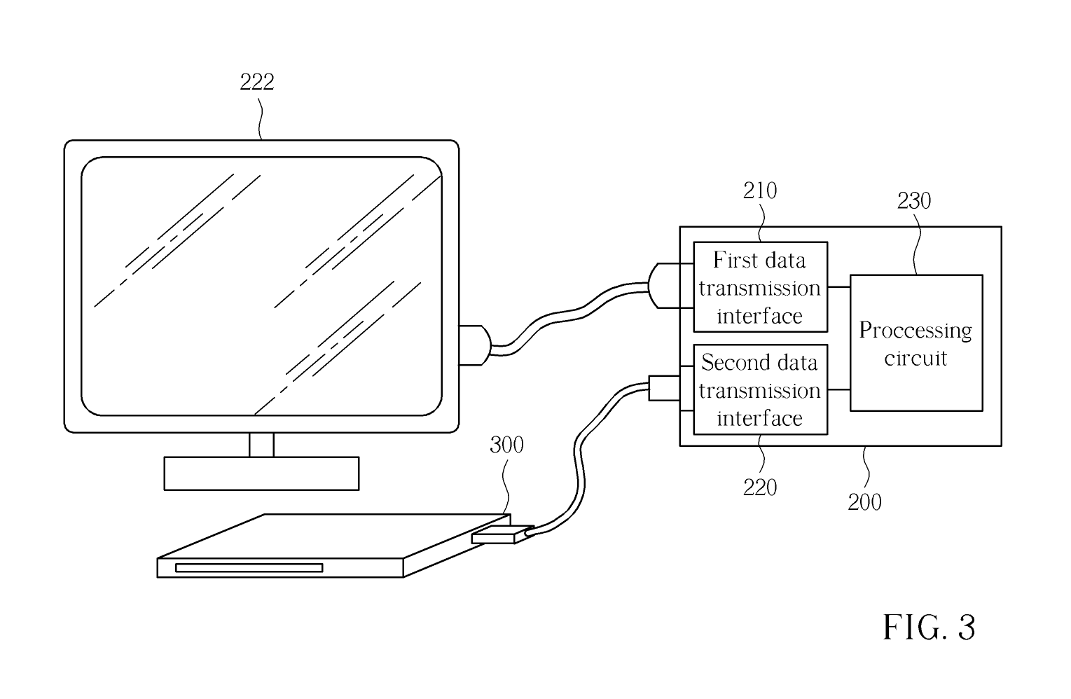

Referring to FIG. 3, FIG. 3 shows an electronic device according to a second exemplary embodiment of the present invention. One of the distinctions between the abovementioned first exemplary embodiment and the second exemplary embodiment includes features that the second data transmission interface 220 may be coupled to a portable electronic device 300, such as a portable hard drive capable of storing electronic data, rather than to the entertainment system 222 such as a HDTV having a loudspeaker system. Thus, the second data transmission interface 220 may be configured to receive power input from a second external power source 221 disposed in the portable electronic device 300. In an exemplary embodiment, second data transmission interface 220 may further transmit and/or receive data to the electronic device 300 and vice versa. For example, as previously mentioned, the portable electronic device 300 may be a data storage device, the electronic device 200 is able to read data from the portable electronic device 300 through the second data transmission interface 220 via a connection cable, and the processing unit 230 may perform some specific operations upon the read data and then output to the HDTV 222. In this exemplary embodiment, the electronic device 200 receives electrical power both from the first power source 211 disposed in the entertainment system 222 and the second power source 221 disposed in the portable electronic device 300. Consequently, the electronic device 200 may then be supplied with a required electrical power from the second external power 221 source regardless of the fact that the entertainment system 222 may only have one power source 211 supplying power to the electronic device 200. In a particular illustrative example, the first data transmission interface 210 may preferably be an HDMI interface and the second data transmission interface 220 may preferably be an USB interface circuit. In other words, the first data transmission interface 210 may of a first data transmission standard or type differ from the second data transmission standard or type of the second data transmission interface 220.

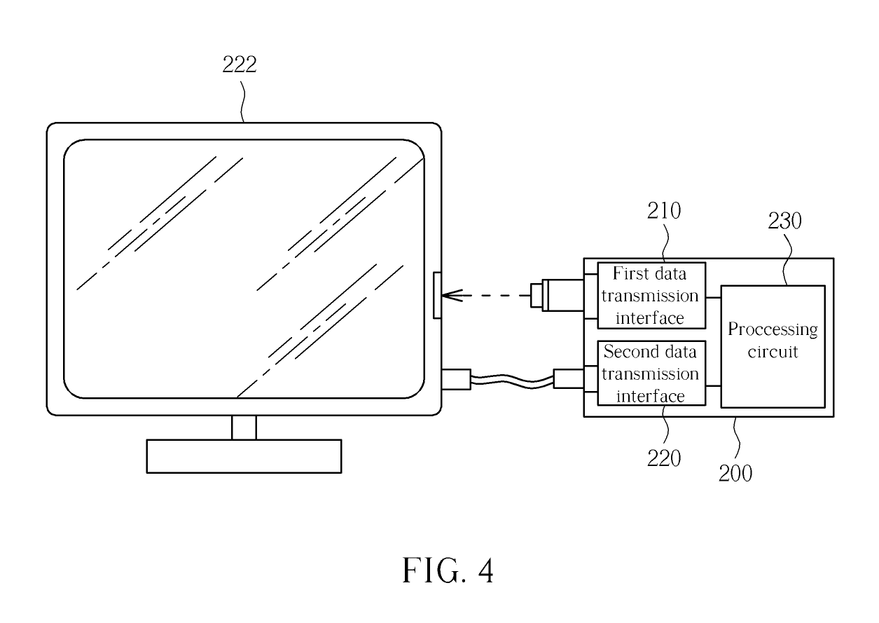

FIG. 4 shows an electronic device according to a third exemplary embodiment of the present invention. In the third exemplary embodiment of the present invention, the electronic device 200 may be a dongle apparatus; in other words and by means of interpretation only but not limitation, the first data transmission interface 210 may be a connector directly inserted into a receptacle of the entertainment system 222 without any connection cable. Further, the second data transmission interface 220 may be connected to a receptacle of the entertainment system 222 via a connection cable. In this exemplary embodiment, the first data transmission interface 210 and the second data transmission interface 220 are utilized to receiving electrical power from the first external and the second power sources disposed in the entertainment system 222. In a particular and illustrative example, the first data transmission interface 210 may preferably be an HDMI interface and the second data transmission interface 220 may preferably be a USB interface circuit. In other words, the first data transmission interface 210 may of a first data transmission standard or type differ from the second data transmission standard or type of the second data transmission interface 220.

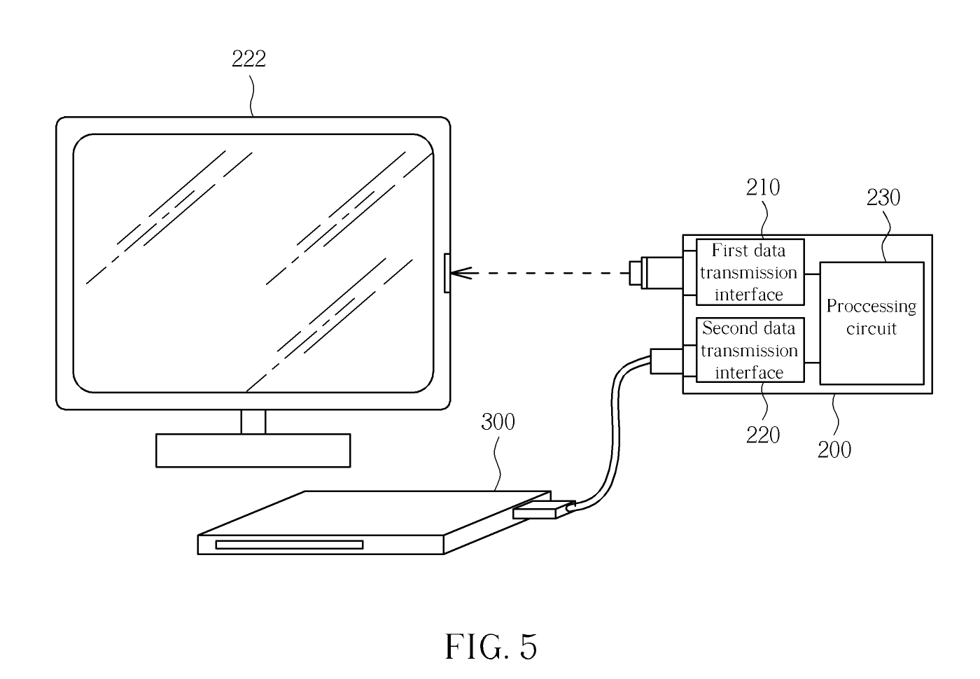

FIG. 5 shows an electronic device according to a fourth exemplary embodiment of the present invention. In the fourth exemplary embodiment of the present invention, the electronic device 200 may be a dongle apparatus, and the second data transmission interface 220 receives electrical power from the second external power source 221 disposed in the portable electronic device 300 by utilizing a connection cable.

The present invention further provides a method of supplying electric power to an electronic device said method comprises the steps of utilizing a first data transmission interface to receive a first power input from a first external power source; and utilizing a second data transmission interface to receive a second power input from a second external power source. As described above, the first data transmission interface and the second data transmission interface may be of a first data transmission standard and a second data transmission standard, respectively; wherein the first data transmission standard or type differs from the second data transmission standard or type. In another exemplary embodiment of the present invention, the first and the second external power sources may be both disposed in another electronic displays or display means (e.g. HDTV) or other entertainment media devices. In still another embodiment of the present invention, the first and the second data transmission interfaces may transmit/receive data to other external electronic devices and vice versa.

It can be understood that in the foregoing exemplary embodiments, the electronic device 200 may receive electrical power via both of the first data transmission interface 210 and the second data transmission interface 220, the electronic device 200 may too receive electrical power via either one of the first data transmission interface 210 and the second data transmission interface 220 rather than both.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

The present invention utilizes data transmission interfaces of different data transmission standards to receive electrical power from external power sources to supply the inventive electronic device with sufficient power. Therefore, the inventive electronic device can have the flexibility of power supplying and data transmission

Those skilled in the art will readily observe that numerous modifications and alterations of the device and method may be made while retaining the teachings of the invention.

What is claimed is:

1. An electronic device capable of receiving at least one power input utilizing at least one data transmission interface, comprising:
a first data transmission interface of the at least one data transmission interface configured to receive a first power input of the at least one power input from a first external power source; and
a second data transmission interface of the at least one data transmission interface configured to receive a second power input of the at least one power input from a second external power source; and
wherein the first data transmission interface is of a first data transmission standard different from a second data transmission standard of the second data transmission interface.

2. The electronic device of claim 1, wherein the first data transmission interface is configured to transmit data to an externally connected entertainment system, and the first external power source is disposed in the entertainment system.

3. The electronic device of claim 2, wherein the second external power source is disposed in the entertainment system.

4. The electronic device of claim 3, wherein the second data transmission interface is configured to transmit data between the electronic device and the entertainment system.

5. The electronic device of claim 2, wherein the second external power source is disposed in an externally connected portable electronic device.

6. The electronic device of claim 1, wherein the first data transmission interface comprises HDMI interface.

7. The electronic device of claim 6, wherein the electronic device comprises an HDMI dongle.

8. The electronic device of claim 1, wherein the second data transmission interface comprises an USB interface.

9. A method of supplying electrical power to an electronic device with, comprising the steps of:
configuring a first data transmission interface to receive a first power input from a first external power source;
configuring a second data transmission interface to receive a second power input from a second external power source; and
wherein the first data transmission interface is of a first data transmission standard different from a second data transmission standard of the second data transmission interface.

10. The method of claim 9, further comprising the step of configuring the first data transmission interface to transmit data between the electronic device and an entertainment system, and the first external power source is disposed in the entertainment system.

11. The method of claim 9, further comprising the steps of configuring the second data transmission interface to transmit data between the electronic device and the entertainment system.

12. The method of claim 9, wherein the first data transmission interface comprises an HDMI interface.

13. The method of claim 12, wherein the electronic device comprises a HDMI dongle.

14. The method of claim 9, wherein the second data transmission interface comprises an USB interface.
